(19) United States
(12) Patent Application Publication
(10) Pub. No.: US 2019/0184331 A1
(43) Pub. Date: Jun. 20, 2019

(54) TRAY FOR EXCHANGE COLUMN COMPRISING GAS CHIMNEYS SURMOUNTED BY HATS WITH A STREAMLINED PROFILE

(71) Applicant: IFP Energies nouvelles, Rueil-Malmaison Cedex (FR)

(72) Inventors: Yacine HAROUN, Lyon (FR); Rim BRAHEM, Lyon (FR); John ROESLER, Vienne (FR)

(73) Assignee: IFP Eneriges nouvelles, Rueil-Malmaison Cedex (FR)

(21) Appl. No.: 16/220,260

(22) Filed: Dec. 14, 2018

(30) Foreign Application Priority Data
Dec. 15, 2017 (FR) 17/62.231

(51) Int. Cl. B01D 53/18; B01D 3/00; B01J 19/32; B01J 19/30

(52) U.S. Cl. CPC B01D 53/185; B01J 19/30; B01J 19/32; B01D 3/008

(57) ABSTRACT

A tray (100) for a gas/liquid contact column, comprising a plurality of chimneys (108) jutting over a portion (101) of the upper face of the tray for the exclusive passage of gas through the tray; they are substantially parallelepipedal and mutually parallel. At least one of the chimneys (108) is surmounted by an elevated hat (108′) with a streamlined profile which prevents the passage of liquid through the chimney. The hat comprises a lower body (180) which is substantially semi-cylindrical, elongated along the longitudinal axis Y and open towards the top, extended laterally by two planar fins (181, 182) inclined towards the axis of revolution (R) of the lower body at an angle θ in the range 0° to 30° with respect to the axis Z passing through the chimneys, aligned with their height.

### FIELD OF THE INVENTION

The present invention relates to the field of gas distributor trays for gas/liquid contact columns, and more particularly to columns for gas treatment units, for the capture of carbon dioxide (CO₂), for the dehydration of a gas, or in fact for distillation.

### GENERAL CONTEXT

Units for the treatment of gas and/or for the capture of CO₂ by amine scrubbing and/or distillation and/or dehydration of a gas comprise columns for the exchange of matter and/or heat between a gas and a liquid. They may, for example, be columns for the absorption and regeneration of liquid or gaseous fluids. These columns function with a gas/liquid flow in counter-current or co-current mode.

In the present description, these columns for the exchange of matter and/or heat between a gas and a liquid will be interchangeably termed gas/liquid exchange columns or gas/liquid contact columns.

The gas/liquid contact columns used in these gas treatment units and/or CO₂ capture units and/or distillation units and/or dehydration units generally function on the principle of an exchange of matter and/or heat between the gas and the fluid which moves in the columns.

When contaminants present in the gas, such as CO₂, water, hydrogen sulphide (H₂S), carbon oxysulphide (COS), are to be removed using processes for scrubbing with a liquid, in general, vertical gas/liquid contact columns are used which scrub an ascending stream of gas moving as a counter-current with a descending stream of liquid. Thus, as the gas rises in the column, the contaminants of the gas are retained at a variety of absorption rates by the liquid. In the context of the absorption of contaminants in a gas, the term “vertical contact column” also means regeneration towers in which the solvents (liquids) charged with contaminants are purified by contact with a gas, which promotes extraction of the contaminants present in the solution charged with contaminants. The units are generally composed of two gas/liquid contact columns, one dedicated to the absorption of the contaminants, such as acidic compounds in the gaseous form, by the solvent flowing along the absorption column, also known as the absorber, the other being dedicated to the regeneration (“regenerator”) of the solvent containing the contaminants obtained from the first gas/liquid contact column, also termed the rich solvent, for example by adding heat by boiling said solvent, in a manner such as to completely purify the solvent which is then re-used in the absorber. The regenerated solvent is also termed the depleted solvent.

A wide variety of types of gas/liquid contact columns exists.

FIG. 1 represents a possible embodiment of a column for the exchange of matter and/or heat between a gas and a liquid, for example in the context of the absorption of acidic compounds contained in the gas by the liquid which is an aqueous solution of amine(s). It is a vertical gas/liquid contact column comprising contact internals of the bulk packing and/or structured packing type, and employing several beds of packing with intermediate redistribution of the stream of liquid.

Packings termed bulk packings and packings termed structured packings form the two major families of packings which are currently available. A bulk type packing is constituted by multiple individual solid elements, which may be identical and which are generally moderate in size (of the order of one centimetre), deposited loosely inside contactors, while a structured type packing is generally formed by shaped steel sheets arranged in a particular manner.

As can be seen in FIG. 1, the gas/liquid contact column 1 contains packing, bulk and/or structured, distributed over several beds of packing 7. The contact column 1 receives the gaseous fluid FA to be treated, containing acidic compounds to be eliminated, at the bottom of the column, and the depleted solvent SP (liquid amine(s) solution) at the column head. The gaseous fluid to be treated FA is generally introduced at the bottom of the column with the aid of a gas distributor 2 which can make the velocity profile of the rising gas as uniform as possible over the whole of the lower section of the bed of packing 7 in order to improve the operational performances of the column. The contact column 1 delivers the treated gaseous fluid FT, purified of a portion of the acidic compounds, at the column head, and the rich solvent SR, charged with a portion of the acidic compounds contained in the gaseous fluid to be treated, at the column bottom. The transfer of acidic compounds from the gaseous fluid to the liquid solvent is operated by bringing the descending liquid phase into intimate contact with the ascending vapour phase inside the column, at the level of the beds of packing 7. The beds of packing 7 are composed of solid elements which have a high contact surface area, over which the liquid is distributed in a uniform manner and flows towards the bottom, which promotes contact with the rising vapour phase, and thus can efficiently transfer matter and/or heat between the two fluids.

For all of the types of packing, in order to make the entire surface developed by the transfer internals available, each of the streams flowing as a counter-current should flow in a manner which is as uniform as possible over the whole of the section of the column and the contact internals of the column. To this end, the depleted solvent SP at the column head is injected in a uniform manner over the section of the head bed of packing 7 with the aid of a liquid distributor 3, and the gas to be treated FT is introduced into the bottom of the contactor with the aid of a gas distributor 2. The column 1 also comprises a plurality of systems 4, 5 for the collection and redistribution of liquid between the beds of packing 7. The column 1 shown thus comprises two such liquid collection and redistribution systems 4, 5, each being placed between two beds of packing 7 to allow, on the one hand, the collection of descending liquid from the upper bed of packing and allowing said liquid to be distributed over the lower bed of packing, and on the other hand the distribution of the gas from the lower liquid bed of packing uniformly over the upper bed of packing. This configuration is particularly suitable when a high gas/liquid contact height is required. These intermediate liquid collection and redistribution systems, installed here between two beds of packing 7, may be of different types such as, for example, systems comprising a liquid collector tray 4 comprising chimneys for the passage of gas, associated with a distributor 5 comprising a vertical conduit discharging onto a plurality of sprinklers (horizontal tubes provided with orifices or nozzles) for the distribution of liquid collected on the tray 4.

In general, the gas distributor 2 disposed at the bottom of the column also collects the liquid SR which may then be extracted from the bottom of column 1. The liquid SR is generally collected in a liquid collection zone provided over the gas distributor 2, said zone conventionally being connected to the bottom of the column via legs discharging into a liquid trap zone from which the liquid is withdrawn from the column 1.

In particular, the present invention pertains to a tray for the distribution of gas or gas and liquid, of the type having chimneys for the passage of gas, also known as chimney trays. It may be a device for the distribution of gas and for the collection of liquid disposed at the bottom of the column, such as the device 2 in FIG. 1, or in fact a device for the distribution of gas, for the collection and redistribution of liquid disposed between the gas/liquid contactors of the column, typically between the beds of packing, such as the devices 4,5 of FIG. 1.

As mentioned above in the description of the column represented in FIG. 1, a good distribution of the gas and liquid phases is important in order to ensure proper operability of the column as well as good transfer of matter and/or heat, guaranteeing compliance with the required specifications pertaining to the products (for example treated gaseous fluid. FT purified of a portion of the acidic compounds such as CO₂, H₂S, COS).

In particular, the importance of the quality of the gas distribution increases with the diameter of the column and with the capacity of the packing used to bring the gas and the liquid into contact. The term “capacitive packing” means a packing with a large capacity. The term “capacitive packing” means the maximum quantity of gas which can circulate without flooding the column with respect to a given liquid flow rate, i.e. without generating the accumulation of liquid in a portion of the packing. The capacity of a packing depends on a number of factors (angle of channels, shapes of elements, etc); it is generally inversely proportional to its specific surface area (also known as the geometric area), which is the contact surface area per unit volume (expressed as m²/m³). In fact, using a capacitive packing means that the phenomenon of flooding of the column can be retarded, and also means that the linear pressure drop in the packing can be reduced. The term “linear pressure drop” means the total pressure drop in relation to its height.

Thus, more particularly for columns for the exchange of matter and/or heat between a gas and a liquid with a wide diameter, typically with a diameter of 1 metre or more, the gas distribution system at the column bottom, or in fact the system for the redistribution of gas and liquid located between two beds of packing of the column, becomes important, because the good distribution of gas generally provides a gain in capacity and in performance, which results in a reduction in the size of the column and therefore in its cost.

Chimney trays are widely employed in existing column bottom gas distribution systems or in intermediate gas and liquid redistribution systems (between the beds of packing). In particular, chimney trays are routinely employed in the case of applications necessitating high gas flow rates.

FIG. 2 illustrates such a chimney tray in conventional use as a gas and liquid redistribution system installed between two successive beds of packing, which can collect the liquid obtained from an upper bed of packing and redistribute it towards the lower bed of packing, while ensuring the passage of gas from the lower bed of packing towards the upper bed of packing. The tray 10 is provided with chimneys 18 for the passage of gas, the chimneys being covered by “hats” 18′ to prevent the passage of liquid inside the gas chimneys (when in the counter-current flow situation), and is provided with orifices 12 for the passage of liquid. A liquid trap becomes established over the whole section of the liquid and gas distributor tray 10, which supplies the lower contact bed (packing) in the column via the orifices 12 which are uniformly distributed over the bottom of the tray, while the gas is routed via the chimneys 18. This type of tray is described, for example, in patent application EP 2 653 204.

FIG. 3 illustrates a chimney tray used as a gas distributor tray at the column bottom. An example of such a distributor is, for example, marketed by Sulzer Chemtech and proposed in the commercial document “Internals for packed columns” (Sulzer Chemtech, Commercial Brochure 22.51.06.40—V.13, page 16). In this type of gas distributor, a tray 20 is provided with a plurality of chimneys 28 for the passage of gas through the tray 20. In accordance with a counter-current operational mode of the column, each chimney 28 allows the passage of gas from the lower portion of the column towards the upper portion of the column. The chimneys 28 jut from the upper face of the tray 20 orientated towards the top of the column, and are disposed orthogonal to the plane formed by the tray 20. Each chimney 28 is formed from a plurality of walls which define an internal volume open to either side of the tray 20. For each chimney 28, the gas exhaust opening located on the upper face of the tray 20 has a hat 28′ over it which can prevent the liquid from passing into the chimneys 28 while allowing the gas to pass through a gap left between the hat and the chimney. The tray 20 also comprises a collection zone 29 for liquid for the recovery of liquid descending in the column and falling onto the tray 20 between the chimneys 28. This collection zone 29 is a cavity of the tray 20 located at its periphery, delimited on one side by a weir 29′ which corresponds to a vertical portion of the tray, and on the other side by the wall of the shell of the column to which the tray 20 will be fixed. This collection zone 29 is generally connected to a lower zone of the column where a liquid trap is formed and from which the liquid can be withdrawn from the column (not shown).

The tray 20 has a generally circular shape in top view, and comprises a first planar portion 21 supporting the chimneys 28, in the shape of a truncated circle in top view, a second planar portion 29′ which is substantially parallel to the first planar portion, located at a level which is lower than that of the first portion of the tray, and connected to the first portion via the weir 29′, which is a third planar portion orthogonal to the tray. Thus, the collection zone 29 is the volume formed in part by the weir 29 and the second planar portion 29′ of the tray, the other portion being the wall of the shell of the column (not shown).

On the tray 20 shown, 12 chimneys in the form of rectangular parallelepipeds which are elongated along an axis parallel to the plane formed by the weir 29′, are thus disposed in a manner which is aligned in pairs either side of a central conduit dividing the first portion of the tray into two equal portions, said conduit discharging into the collection zone 29 delimited by the weir 29′ and the second lower planar portion 29′ of the tray.

In other chimney tray type gas distributors in accordance with the prior art, the chimneys for the passage of gas may have other shapes and a different disposition to that of the gas distributor trays illustrated in FIGS. 2 and 3. This is also the case for the hats covering the chimneys, which may have other shapes, or for the liquid collection zone, which may be disposed over the entire periphery of the tray, or be divided into two diametrically opposed zones at the periphery of the tray.

FIG. 4 is a partial view of another example of a chimney tray described in the patent U.S. Pat. No. 4,744,929 A, which concerns packing support devices comprising chimney trays for columns for exchange between a downflow of liquid and an upflow of gas. The tray 30 comprises chimneys 38 for the passage of gas, in the form of a rectangular parallelepiped disposed in parallel over the tray 30 and between them defining channels 36. The chimneys 38 comprise streamlining formations 35 and 38′ at the base and chimneys at the top in order to improve the flow of gas. The formations 38′ form hats in the shape of a half-cylinder mounted above the chimneys and also functioning to collect liquid which overflows at the longitudinal ends of the chimneys into sumps disposed at the periphery of the tray or traversing the tray (not shown). The channels 36 collect the liquid not harvested by the hats 38′, which also overflow into the sumps.

However, the chimney tray type gas distributors in accordance with the prior art are not always satisfactory and might generate gas velocities which are not perfectly homogeneous, and this is accentuated all the more when the diameter of the column is large.

Furthermore, there is a constant desire to minimize the pressure drop caused by the presence of a tray inside a gas/liquid contact column. In fact, pressure drops represent losses of energy, and are generally undesirable. The pressure drops are even more problematic when the envisaged process is carried out at relatively low pressures, as is the case with processes for the capture of CO₂, for example from combustion fumes, typically carried out at pressures in the range 1 to 5 bar.

### OBJECTIVES AND SUMMARY OF THE INVENTION

The aim of the present invention is to provide an improved chimney tray type tray to distribute gas or gas and liquid for use, for example, in large diameter columns (typically with a diameter of at least 1 metre), which in particular can provide better homogenization of the gas velocity downstream of the tray (“downstream” being defined with respect to the direction of the stream of gas ascending in the column), while minimizing the pressure drop linked to the passage of gas through said tray.

Thus, in order to achieve at least one of the objectives envisaged above, inter alia, in a first aspect, the present invention proposes a tray for a column for the exchange of heat and/or matter between a gas and a liquid, comprising:
an upper face and a lower face,
a plurality of chimneys jutting over a portion of the upper face of the tray for the exclusive passage of gas through the tray, the chimneys comprising an opening for the escape of gas at their top, an axis Z passing through them in the direction of their height and being elongated along a longitudinal axis Y orthogonal to the axis Z, and being substantially parallelepipedal and mutually parallel, and
   in which at least one of the chimneys is surmounted by a hat with a streamlined profile in order to prevent the passage of liquid through the chimney, the hat being elevated with respect to the gas escape opening of the chimney, and the hat comprising a lower, substantially semi-cylindrical body which is elongated along the longitudinal axis Y and open on the side opposite to the escape opening of the chimney, extended laterally by two planar fins inclined towards the axis of revolution (R) of the lower body at an angle θ in the range 0° to 30° with respect to the axis Z.

In accordance with one embodiment, each chimney is surmounted by a hat with a streamlined profile.

In accordance with one embodiment, the diameter of the lower body of the hat is preferably at least equal to the width of the chimney.

In accordance with one embodiment, the length of the lower body of the hat is preferably at least equal to the length of the chimney.

In accordance with one embodiment, the lower body comprises a section in the form of an arc of a circle with a length that is less than or equal to that of a semi-circle and has an axis of symmetry which coincides with the axis Z, and defines an angle β formed between the centre O of the circle, the axis X and the junction J between a fin and the lower body which is in the range 0° to 30°.

In accordance with one embodiment, the lower body is a half-cylinder.

In accordance with one embodiment, the lower body comprises a section in the form of an arc of a circle with a length that is less than or equal to that of a semi-circle and has an axis of symmetry which coincides with the axis Z, and the length (a) of the fin is in the range 10 mm to a maximum value aₘₐₓ which is equal to aₘₐₓ=(D*cos(β))/(2*sin(θ)), in which β is the angle formed between the centre O of the circle, the axis X and the junction J between the fin and the lower body, θ is the inclination of the fins with respect to the axis Z, and D is the diameter of the lower body.

In accordance with one embodiment, the fins are substantially in the shape of a rectangle.

In accordance with one embodiment, the chimneys are substantially in the shape of a parallelepipedal rectangle.

In accordance with one embodiment, at least one of the chimneys, and preferably all of the chimneys, comprises a dispersive element for gas disposed inside the chimney, the dispersive element preferably comprising a perforated plate comprising circular orifices or slots for the passage of gas.

In accordance with one embodiment, the tray furthermore comprises means for the passage of liquid through the tray and/or a liquid collection zone.

In accordance with one embodiment, the tray can be used for the distribution of gas at the bottom of a column for the exchange of heat and/or matter between a gas and a liquid, and the collection zone comprises two weirs which are diametrically opposed and orthogonal to the portion of the upper face of the tray supporting the chimneys, the chimneys extending parallel to the weirs.

In accordance with one embodiment, the tray can be used for the distribution of gas and liquid in a column for the exchange of heat and/or matter between a gas and a liquid, and the means for the passage of liquid through the tray comprise a plurality of orifices and/or chimneys for the passage of liquid.

In accordance with a second aspect, the present invention proposes a column for the exchange of heat and/or matter between a gas and a liquid, comprising at least one gas/liquid contactor bringing the gas and the liquid into contact, and at least one tray in accordance with the invention to distribute the gas, and optionally the liquid, over the gas/liquid contactor.

In accordance with one embodiment, the tray is disposed at the bottom of the column upstream of any gas/liquid contactor in order to distribute the gas at the base of the gas/liquid contactor.

In accordance with one embodiment, the column has a plurality of sections, each of the sections comprising a gas/liquid contactor, and a tray in accordance with the invention is disposed between an upper section and a lower section, the upper and lower sections being successive in the column, in order to distribute the gas at the base of the gas/liquid contactor of the upper section and to distribute the liquid at the top of the gas/liquid contactor of the lower section.

In accordance with a third aspect, the present invention proposes the use of a column in accordance with the invention for a process for the treatment of gas, for the capture of CO₂, for the dehydration of a gas, or for distillation.

Other objects and advantages of the invention will become apparent from the description below which is followed by particular exemplary embodiments of the invention, given by way of non-limiting examples, the description being made with reference to the accompanying drawings described below.

### BRIEF DESCRIPTION OF THE FIGURES

FIG. 1, as already described, is a diagram illustrating a particular case of a gas/liquid contact column for the absorption of acidic compounds contained in a gas using an aqueous amine solution, in the context of treatment of a gas or capture of CO₂, equipped with a distributor tray in accordance with the prior art or in accordance with the invention.

FIG. 2, as already described, illustrates a chimney tray in accordance with the prior art for the collection of liquid and the distribution of liquid and gas.

FIG. 3, as already described, illustrates a gas distributor chimney tray in accordance with the prior art which can be placed at the bottom of a gas/liquid contact column.

FIG. 4, as already described, illustrates another example of a prior art chimney tray.

FIG. 5 is a perspective view illustrating a gas distributor tray in accordance with one embodiment of the invention.

FIG. 6 is a sectional diagram of a hat of a chimney of a distributor tray in accordance with the invention.

FIG. 7 illustrates the interior of a chimney of a tray in accordance with one embodiment of the invention.

FIGS. 8 and 9 are images of the velocity fields for a gas, obtained by modelling the function of a chimney tray distributor in accordance with the prior art and in accordance with one embodiment of the invention.

In the figures, identical reference numerals designate identical or analogous elements.

### DESCRIPTION OF THE INVENTION

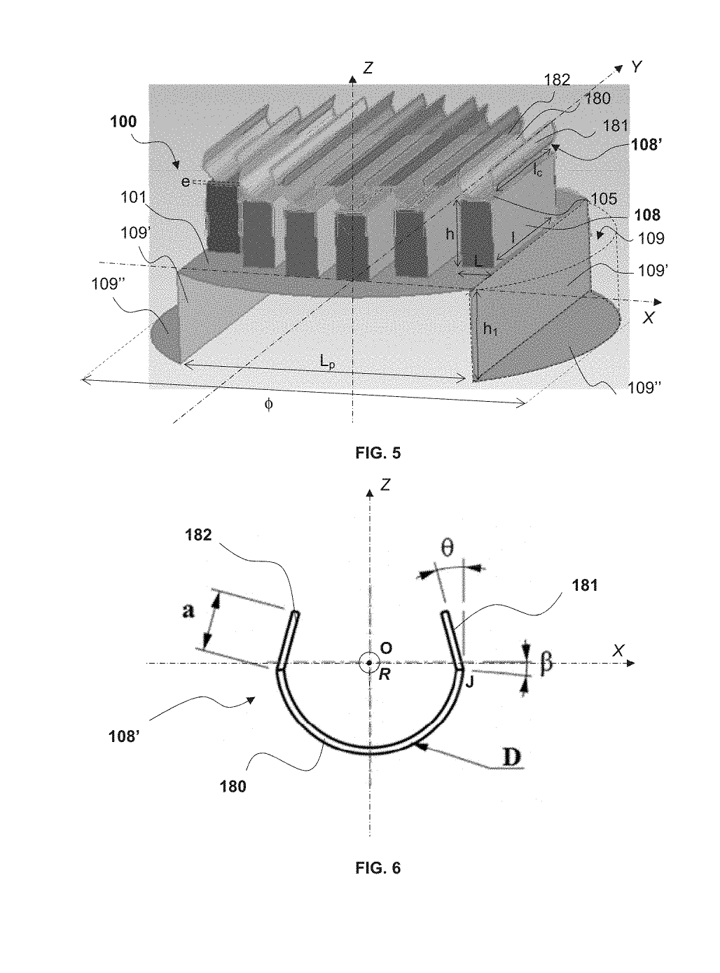

The detailed description of the tray in accordance with the invention below refers to FIGS. 5 and 6, illustrating a non-limiting embodiment of the tray.

The tray 100 is shown in a perspective view in FIG. 5, in its position of use in a gas/liquid contact column. As is conventional, the tray 100 is inscribed in a cylinder with a diameter 100 , which is substantially equal to that of the gas/liquid contact column. The tray in accordance with the invention is well suited for use in large diameter columns, typically 1 metre or more, and preferably 3 in or more; they may reach 7 to 8 m, for example.

The tray 100 for the column for the exchange of heat and/or matter between a gas and a liquid comprises a plurality of chimneys 108 jutting over a portion 101 of the upper face of the tray for the exclusive passage of gas through the tray 101.

The term “upper face of the tray 100” is used for the face of the tray which is orientated towards the top of the exchange column. In contrast, the “lower face” of the tray is that which is orientated towards the bottom of the column via which the gas arrives.

The tray 100 may comprise means for the passage of liquid through the tray (not shown) and/or a liquid collection zone 109.

The term “plurality of chimneys” means at least two chimneys. The number of chimneys may vary and depends on the design of the tray, in particular on parameters such as the size of the tray, the desired number of openings for gas, the volume of the collection zone, etc. By way of solely non-limiting indication, the tray may comprise in the range 2 to 100 chimneys 108, for example in the range 3 to 32 chimneys.

An axis Z passes through the chimneys 108 in the direction from their height and is coincident with the vertical when the tray is in the position of use in the column. The chimneys 108 are substantially parallelepipedal in shape, preferably rectangular, and are elongated along a longitudinal axis Y orthogonal to the axis Z, and are mutually parallel in disposition. Each chimney 108 is formed by a plurality of walls which delimit an internal volume that is open to either side of the tray 100. They thus comprise a gas escape opening 105 at the top. At their base, they comprise an inlet opening for gas coming from the lower portion of the distributor tray 100.

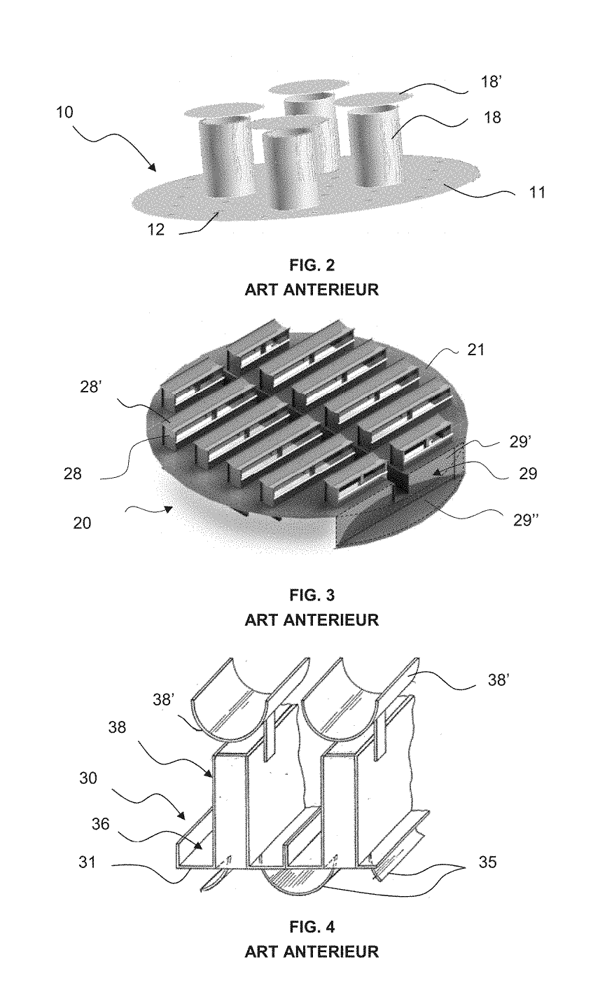

Preferably, a regular gap separates the chimneys 108. The shape of the parallelepiped, preferably rectangular, produces a wide opening for the passage of gas, in particular in comparison with known cylindrical chimneys such as those used in FIG. 2; this means that pressure drops can be limited.

The length 1 and width L of the chimney 108 are defined in the plane (XY) formed by the portion 101 of the tray supporting the chimneys 108, which is the horizontal plane when the tray is in the position of use in a column. For the purposes of simplification, reference will be made in the remainder of the description to a horizontal plane/axis, or in fact to “the horizontal”, to designate any plane/axis contained in the plane formed by the portion of the chimney tray support. The height h of the chimney is defined in a plane orthogonal to that formed by the portion of the tray supporting the chimneys, i.e. in a vertical plane when the tray is in the position of use in a column. The axis Z passes through the chimney, as described above, and is therefore an axis which is orthogonal to the plane XY formed by the portion 101 supporting the chimneys 108. The gas passes through the chimney 108 in the direction of its height, along this axis Z. For the purposes of simplification, reference will be made in the remainder of the description to a vertical plane/axis, or in fact to “the vertical”, to designate any plane/axis contained in a plane orthogonal to the plane formed by the portion of the chimney support tray.

By way of non-limiting example, the height of the chimneys may be in the range 0.15 m to 1.00 m, and preferably in the range 0.2 m to 0.6 m.

At least one chimney 108 is surmounted by a hat 108′ in order to prevent the passage of liquid through the chimney, the hat 108′ being elevated with respect to the escape opening for gas so as to leave a gap e for the passage of gas and the hat 108′ comprising a streamlined profile. The hat thus comprises a lower body 180 which is substantially semi-cylindrical, elongated along the axis Y and open on the side opposite to the escape opening 105 of the chimney, extended laterally by two planar fins 181, 182 which are inclined towards the axis of revolution R of the lower body 180 by an angle θ in the range 0° to 30° with respect to the axis Z. Preferably, the angle θ of inclination of the fins is in the range 5° to 20°, and is, for example, equal to 15°. It should be understood that because the lower body 180 is open on the side opposite to the escape opening 105 of the chimney 108, i.e. towards the top of the column when the tray is in the position of use, it is a portion of a hollow cylinder; there is no material in this lower substantially semi-cylindrical portion of the hat.

The diameter D of the lower body 180 of the hat 108′ is preferably at least equal to the width L of the chimney 108.

The length l_{c} of the lower body 180 of the hat 108′ is preferably at least equal to the length 1 of the chimney 108.

The term “substantially semi-cylindrical” means that the lower body 180 forms a half-cylinder or almost half a cylinder, i.e. it comprises a section in the form of a circular arc with a length which is less than or equal to that of a semi-circle, having an axis of symmetry which is coincident with the axis Z, and defining an angle β formed between the centre O of the circle, the axis X and the junction J between a fin and the lower body which is in the range 0° to 30°. This angle β is equal to 0°, for example. The streamlining of the hat profile increases with the value of the angle β. FIG. 6 illustrates in detail the profile of the hat 108 of a tray in accordance with the invention, which shows the angles θ and β, and the characteristic dimensions of the two portions 180 and 181/182 of the hat.

Put another way, the section in the form of an arc of a circle has an axis of symmetry which coincides with the axis Z, and the angle of the angular sector defining the arc of a circle formed by the section of the lower body is in the range (180−2×β) to 180°, i.e. in the range 120° to 180°.

The term “elevated element” means that the base of said element is at a level (elevation) which is more elevated with respect to a reference surface. Thus, a hat 108′ which is elevated with respect to the gas escape opening 105 of the chimney means that the base of the hat is at a higher elevation than the gas escape opening of the chimney, in this case at a height e from the opening 105.

By way of non-limiting example, the gap between the hat and the gas escape opening of the chimney may be in the range 0.005 m to 0.20 m, and preferably in the range 0.03 m to 0.10 m. By way of non-limiting example, the ratio e/L, i.e. the ratio between the gap e left between the hat and the gas escape opening of the chimney and the width L of the chimney, is preferably in the range 1/16 to 8/5, and preferably in the range 1/4 to 1.25, in order to comply with a given kinetic energy factor (ρ·v², in which ρ is the density and v is the velocity), with a view to preventing any flooding of the packing located above the tray.

The two fins 181, 182 are elongated along the longitudinal axis Y of the chimney 108, which is parallel to the axis of revolution R of the lower body 180. The length of the fin (reference not shown) is defined as the largest dimension in the plane formed by the fin. The width a of the fin is the smallest dimension defined in the plane formed by the fin. The width a of the fin is preferably in the range 10 mm to a maximum value aₘₐₓ equal to a=(D*cos(β))/(2*sin(θ)). Preferably, the maximum value aₘₐₓ corresponds to a configuration in which the two fins join up on the axis Z.

Preferably, the fins 181, 182 are in the form of a rectangle.

Advantageously, the length lₐ of the fins 181, 182 is equal to the length l_{c} of the lower body 180 of the hat 108′.

In accordance with one embodiment as shown in FIG. 5, all of the chimneys 108 are provided with a hat with a streamlined profile as described. This configuration means that the distribution of the gas is homogenized better.

In accordance with another embodiment, the tray comprises chimneys provided with a hat with a streamlined profile as described above, as well as chimneys provided with conventional hats, for example flat hats, or in the form of Chinese hats, or semi-cylindrical hats. Preferably, in accordance with this embodiment, the chimneys provided with conventional hats are positioned at the periphery of the tray.

Particularly because of the streamlined profile of the chimney hats as described, the tray in accordance with the invention has good gas distribution quality, which is better, for example, than in the case of a tray with gas chimneys with flat hats or with semi-cylindrical hats, while allowing the pressure drop linked to the use of trays in the column to be limited.

The quality of the gas distribution may be quantified by various means, for example by determining a specific index IQ, defined as follows:

$$\begin{matrix}IQ = 1 - \frac{{\sum }_{i = 1}^{n} ( \vert {u}_{i} - \overline{U} \vert ) {A}_{i}}{2 \vert \overline{U} \vert {\sum }_{i = 1}^{n} {A}_{i}} & ( 1 ) \\ \overline{U} = \frac{{\sum }_{i = 1}^{n} {u}_{i} {A}_{i}}{{\sum }_{i = 1}^{n} {A}_{i}} & ( II )\end{matrix}$$

uᵢ: local velocity over facet i

Aᵢ: surface area of facet of computational mesh

The pressure drop, which is a drop in pressure between two levels of the column, may, for example, be measured using manometers, or estimated using CFD (Computational Fluid Dynamics) during simulations.

The hats 108 may be fixed above the chimneys using any means known to the person skilled in the art, for example by means of fixing tabs attached to the chimney and the hat.

The tray illustrated in FIG. 5 is a gas distributor tray 100 adapted for use in the bottom of a column for the exchange of heat and/or matter between a gas and a liquid functioning using a counter-current flow, with the gas rising from the bottom of the column through the chimneys 108 of the gas distributor tray for the exclusive passage of gas, and the descending liquid being collected in a liquid collection zone 109, which can then be evacuated from said column. A tray of this type does not include liquid distribution means, allowing liquid to be distributed towards a gas/liquid contactor which would be placed upstream (below the tray).

The gas distributor tray 100 thus comprises a liquid collection zone 109 comprising two diametrically opposed weirs 109′ to collect liquid on the tray 100.

The term “weir” means a portion of the tray which is inclined, typically substantially orthogonally, with respect to the portion 101 of the upper face of the tray 100 supporting the chimneys 108, which is positioned at the periphery of the tray and which allows a liquid to overflow towards the base 109″ of the tray 100 located at a lower elevation than that of the portion 101 of the upper face of the tray 100. The elevations are evaluated when the tray 100 is in the non-inclined position (i.e. portion 101 of the tray supporting the chimneys in a substantially horizontal plane XY) and disposed in a manner such that the axis Z passing through the chimneys 108 is vertical, corresponding to the position of use of the tray in the gas/liquid exchange column. This can be transposed to all of the elevations mentioned in the present description.

The weirs 109′ are preferably located at the periphery of the gas distributor tray in two diametrically opposed zones and are orthogonal to the portion 101 supporting the chimneys 108. They are, for example, flat plates connecting the portion 101 supporting the chimneys 108 and the base 109″ of the distributor tray 100 orthogonal to the planes formed by the portion 101 and the base 109″ of the tray 100.

The collection zone 109 is equivalent to a volume which can be calculated from the diameter φ of the cylinder in which the tray 100 is inscribed, the height h₁ of the collection zone defined between the base 109″ of the tray and the portion 101 supporting the chimneys, and the width Lₚ of the portion 101 of the tray.

The collection zone 109 preferably comprises two distinct volumes, each volume being partially delimited by one of the two weirs and a base portion 109″ of the tray. The limits of such a volume for the collection zone 109 are represented in dashed lines in FIG. 5. When the tray is positioned in the gas/liquid contact column, each of the two volumes is then also delimited by the internal wall of the column to which the tray is fixed. The two volumes are open towards the top of the tray, i.e. on the side of the chimneys 108, in a manner such as to collect the liquid, and are closed towards the base of the tray, i.e. at the level of the base 109″ of the tray. Means for evacuating the collected liquid, such as openings in the tray and conduits, not shown, may be provided in the collection zone 109, in particular in the two volumes of the collection zone. Thus, the liquid can be evacuated from the collection zone towards the bottom of the column in a zone of the column where a liquid trap is formed and from which it can then be withdrawn from the column.

In accordance with the embodiment illustrated in FIG. 5, the weirs 109′ are located at the periphery of the tray 100, for example at two opposed ends of the tray. However, in a tray in accordance with the invention which is adapted for placement at the bottom of the column for the distribution of gas, without a liquid redistribution function, the weirs may be located on central sections for the multi-pass trays, depending on the diameter of the column.

The present invention is not limited to a gas distributor tray of this type, which can be disposed in the bottom of a column, without a liquid distribution function. In fact, the tray in accordance with the invention may include both a gas distribution function and a liquid distribution function. It always has a liquid collection function.

In this case, the tray in accordance with the invention may be placed in a column comprising a plurality of sections, each of the sections comprising a gas/liquid contactor, typically a bed of packing, for example a structured bed of packing, and disposed between an upper section and a lower section, the upper and lower sections being in succession in the column, in a manner such as to distribute the gas at the base of the gas/liquid contactor of the upper section and to distribute the liquid at the top of the gas/liquid contactor of the lower section.

The means for the passage of liquid through the tray carrying out the liquid distribution function may comprise, and preferably be, an assembly of chimneys for the passage of liquid jutting over the upper face of the tray and/or over the lower face of the tray. So that the liquid can pass via the chimneys for the passage of liquid and not via the chimneys for the exclusive passage of gas, the chimneys for the passage of liquid are advantageously lower compared with the chimneys for the passage of gas. The chimneys for the passage of liquid may have different shapes, and be substantially cylindrical, or substantially parallelepipedal, and preferably substantially cylindrical.

Alternatively, the means for the passage of liquid through the tray may comprise, and preferably be, an assembly of orifices disposed on the tray, in similar manner to the orifices of the plate in accordance with the prior art illustrated in FIG. 2.

In accordance with another exemplary embodiment of the invention, the means for the passage of liquid through the tray comprise both chimneys and orifices.

These means for the passage of liquid are preferably disposed between the chimneys for the exclusive passage of gas. The number of means for the passage of liquid is advantageously greater than the number of chimneys for the exclusive passage of gas. The pitch of the means for the passage of liquid may be triangular or square. In order to produce a good distribution of liquid and a good apportionment of liquid over the gas/liquid contactor, the means for the passage of liquid are uniformly distributed over the tray, i.e. located over the whole of the surface of the tray, between the chimneys for the passage of gas.

Advantageously, a dispersive element for gas is provided inside at least one of the chimneys 108, i.e. an element which ensures the dispersion of gas as it passes through the chimney, thereby generating better distribution (in the sense of homogenization) of gas in the chimney, and thus at the outlet from the chimney.

Preferably, all of the chimneys of the distributor tray are provided with a dispersive element of this type, in a manner such as to promote homogenization of the stream of gas downstream of the distributor tray.

This dispersive element is preferably positioned at the base of the chimney, for example in the first third of the chimney. By thus being closer to the base of the chimney than its top, the dispersive element can redistribute the gas over the whole of the surface of the chimney while leaving a sufficient height for stabilization of gas which has passed through the chimney.

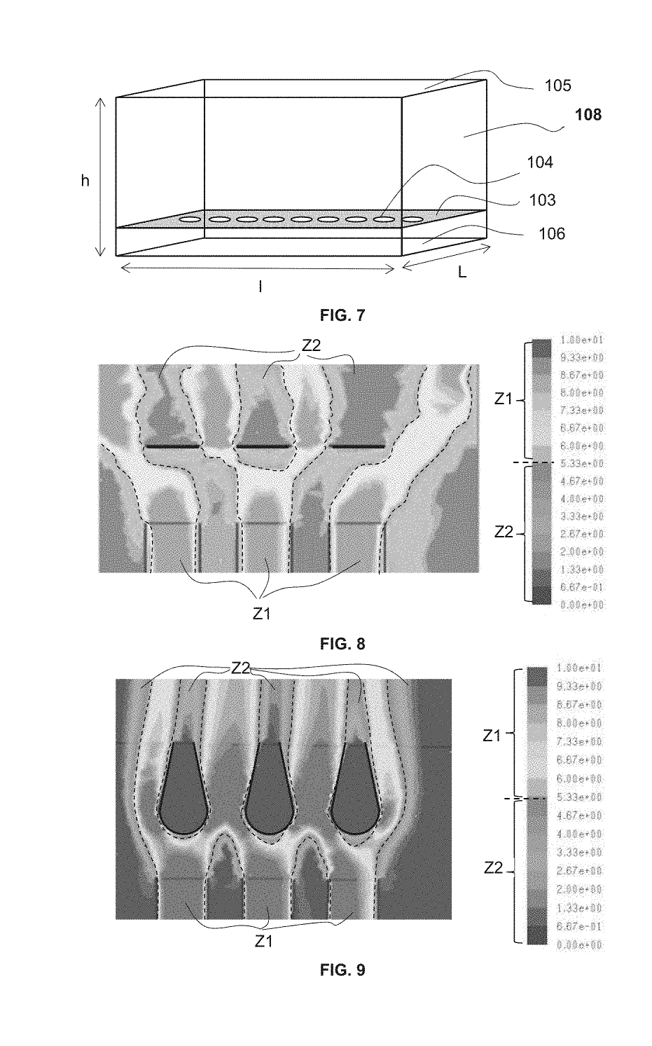

An example of such an embodiment is illustrated in FIG. 7. The dispersive element advantageously comprises a perforated plate 103 comprising circular orifices 104. The plate may alternatively comprise orifices or slots for the passage of gas. The plate 103 is preferably positioned closer to the inlet opening 106 for gas than the gas escape opening 105 of the chimney 108.

The dispersive element may also be a bulk or structured type packing, preferably of the structured type, in particular because a structured packing can be used to provide the dispersive medium with a uniform density. It may also be a combination of one or more of these elements.

The term “bulk packing” is used for disordered, random piles of unitary elements with specific shapes, for example rings, coils, etc. They are generally used to carry out exchanges of heat and/or matter, which occur within these unitary elements. These unitary elements may be formed from metal, ceramic, plastic or analogous materials. The patent applications EP 1 478 457 and WO 2008/067031 describe two examples of a unitary bulk packing element. The bulk packing offers interesting qualities in terms of transfer efficiency, low pressure drop and ease of installation. The geometric area of bulk packing may be in the range 70 to 250 m²/m³. The term “structured packing” is applied to a pile of plates or sheets which are bent and corrugated (i.e. rippled substantially at right angles) and arranged in an organized manner in the form of large blocks as described, in particular, in patent applications FR 2 913 353 (US 2010/0213625), U.S. Pat. No. 3,679,537 and U.S. Pat. No. 4,296,050. They are generally used to carry out exchanges of heat and/or matter which occur on these plates. The structured packings have the advantage of offering a large geometric area for a given representative diameter. The geometric area of structured packing may be in the range 100 to 500 m²/m³.

When the packing is bulk or structured in type, the dispersive element may be distributed inside the chimney or chimneys for the exclusive passage of gas in a uniform manner in the direction of the height of the chimney (along the axis Z) and in a uniform manner along a plane orthogonal to the height of the chimney (in a plane XY). In this manner, the dispersion of the gas passing through the chimney or chimneys is as homogeneous as possible, which means that a constant stream of gas leaves the outlet from the chimney or chimneys over a section corresponding to the section of the chimney or chimneys.

Again, when a bulk or structured type packing is used, the dispersive element may be uniformly distributed in the chimney over a thickness at least equal to 5 cm in the direction of the height of the chimney. In this manner, the particles of gas passing through such thicknesses of dispersion material are sufficiently dispersed to ensure that the stream of gas leaving the chimneys is homogeneous. It may also be distributed uniformly over the entire height of the chimney or chimneys for the exclusive passage of gas.

Again, when a bulk or structured type packing is used, the dispersive element is preferably more capacitive than the packing used as a gas/liquid contactor in the column for the exchange of matter and/or heat between a gas and a liquid, and positioned in the form of a bed occupying the whole diameter of the column.

The invention also concerns a column for the exchange of matter and/or heat between a gas and a liquid, in which the two fluids are brought into contact by means of at least one gas/liquid contactor. A gas/liquid contactor of this type is preferably a bed of structured or bulk packing, as defined above. It may also be any means for gas/liquid contact which can be used to exchange matter and/or heat, such as trays.

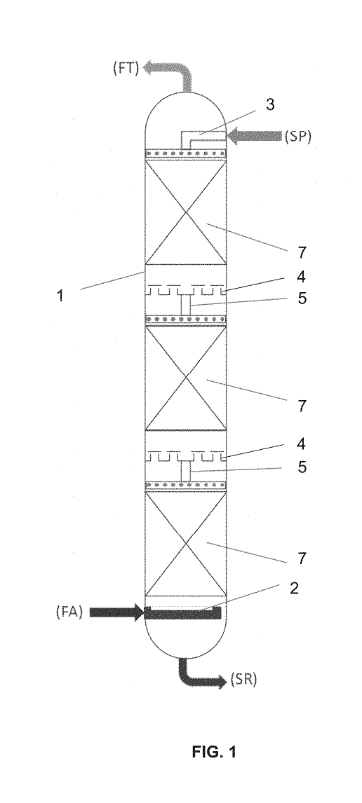

The column in accordance with the invention may be a column as described with reference to FIG. 1, for example adapted to a process for the absorption of acidic compounds such as CO₂, H₂S, COS, carbon disulphide (CS₂), sulphur dioxide (SO₂) and mercaptans (RSH) such as methyl mercaptan (CH₃SH), ethyl mercaptan (CH₃CH₂SH) and propyl mercaptan (CH₃CH₂CH₂SH), contained in a gas to be treated, by the liquid which is an aqueous solution of amine(s). Without an exhaustive repetition of the description already made above of such a column, the column may thus comprise at least one inlet for a liquid (termed the “depleted solvent”) disposed at the top of the column, at least one inlet for a gas to be treated at the bottom of the column, at least one outlet for the treated gas at the top of the column, and at least one outlet for liquid enriched in contaminants initially contained in the gas to be treated at the bottom of the column (termed the “rich solvent”). The column advantageously comprises at least one gas/liquid contactor 7, preferably a bed of structured packing, in order to bring the gas to be treated into contact with the depleted solvent.

The column in accordance with the invention also comprises at least one distributor tray as described above, in order to distribute the gas in a homogeneous manner over the gas/liquid contactor 7, and optionally the liquid, while limiting the pressure drop.

In accordance with one embodiment, the column comprises a distributor tray as described above, and in particular a tray for the distribution of gas and the collection of liquid comprising a liquid collection zone 109 with diametrically opposed weirs 109′, without a liquid redistribution function as illustrated in FIG. 5, disposed at the bottom of the column upstream of any gas/liquid contactor, in order to distribute the gas at the base of said gas/liquid contactor in a homogeneous manner. The distributor tray at the bottom of the column may be preceded by a pre-distribution device for the gas phase (placed upstream of the tray in accordance with the invention).

The column may comprise a plurality of sections, each section comprising a gas/liquid contactor, preferably a bed of structured or bulk packing, and more preferably a bed of structured packing.

In accordance with one embodiment, the column is configured in this manner, and a tray in accordance with the invention is disposed between two successive sections in the column, an upper section and a lower section, in order to distribute the gas at the base of said gas/liquid contactor 7 of the upper section and to distribute the liquid at the top of the gas/liquid contactor of the lower section. Such a tray in accordance with the invention advantageously comprises liquid distribution means, or alternatively is associated with a separate liquid distribution device positioned upstream (in the direction of the flow of gas) which can be used to distribute the liquid collected by the tray in accordance with the invention.

The column in accordance with the invention may be used in a process for the treatment of gas, in particular in a process for the elimination of acidic compounds contained in a gas, by means of a liquid solution based on amine(s), for example in order to treat natural gas, or in a process for the capture of CO₂ which is typically a process for the treatment of gas by means of a liquid solution based on amine(s), for example in order to treat combustion fumes. The column in accordance with the invention may also advantageously be used in a process for the dehydration of gas with the aim of eliminating water (“drying”) contained in a gaseous effluent, such as natural gas, by bringing the gas into contact with a liquid solvent such as glycol, or in fact it may be used in a process for the distillation of liquid. Other types of solvents may be used in these processes where a column in accordance with the invention may be used.

### EXAMPLE

The example below illustrates certain advantages of the present invention, by comparing the results obtained by using a tray equipped with gas passage chimneys in accordance with the invention, and a tray comprising gas passage chimneys in accordance with the prior art, during a three-dimensional digital simulation based on the fluid mechanics of gas alone.

In this simulation, only a section of the distributor tray, composed of three chimneys, was simulated. The distribution quality was measured 45 cm above the distributor tray.

The two tray examples (tray portions) were tested with a surface velocity of gas of 4.3 m/s. The surface velocity of gas in the column is the surface velocity of gas in an empty vessel, which is taken to be the ratio between the volume flow rate of gas under the conditions prevailing in the section (m³/s) of the column and the section of the column (m²).

The example with the tray portion in accordance with the invention had the following features:
diameter of lower body of hat: 0.072 m
angle θ of hat: 15°.
angle β of hat: 0.
pitch of dispersive element in the chimneys:
fin length a: 93 mm
gap e: 6.4 cm
chimney height: 55 cm
number of chimneys: 3

The example with the tray portion in accordance with the prior art had the following features:
type of hat: flat, rectangular in shape
pitch of dispersive element in the chimneys:
gap e: 10 cm
chimney height: 55 cm
number of chimneys: 3

The results of the simulation are presented in Table 1 below, and also in FIGS. 8 and 9.

TABLE 1

| | Pressure drop | | Index IQ |
|---|---|---|---|
| | (mbar) | | (%) |
| Tray in accordance with prior art | 1.688 | mbar | 0.51 |
| (see FIG. 8) | | | |
| Tray in accordance with the invention | 0.0654 | mbar | 0.72 |
| (see FIG. 9) | | | |

The performances of the two trays were evaluated in terms of pressure drop and quality of distribution.

The quality of the gas distribution could be evaluated by calculating an index IQ. This index may take a value in the range 0 to 1, with the limiting values included. A value close to 1 indicates a good distribution quality, and in contrast, a value close to 0 indicates a poor quality of distribution.

This index was calculated as follows:

$$\begin{matrix}IQ = IQ = 1 - \frac{{\sum }_{i = 1}^{n} ( \vert {u}_{i} - \overline{U} \vert ) {A}_{i}}{2 \vert \overline{U} \vert {\sum }_{i = 1}^{n} {A}_{i}} \\ \overline{U} = \frac{{\sum }_{i = 1}^{n} {u}_{i} {A}_{i}}{{\sum }_{i = 1}^{n} {A}_{i}}\end{matrix}$$

uᵢ: local velocity on facet i

Aᵢ: surface area of facet of computational mesh

Referring to Table 1 and FIGS. 8 and 9, it will be observed that the use of the tray in accordance with the invention as exemplified means that the gas distribution quality can be significantly improved, compared with the exemplified prior art tray.

The distribution quality index for the tray in accordance with the invention is in fact 0.72, instead of 0.51 with the distribution elements in accordance with the prior art.

An image of the velocity of the gas is shown in FIG. 8 in the case of a tray in accordance with the prior art, and in FIG. 9 in the case of the tray in accordance with the invention. More precisely, the contours of the gas velocity fields are given in shades of grey, the scale being shown on the right hand side of each figure, giving the gas velocities in (m/s). The zones Z1 and Z2 have been drawn so that the shades of grey associated with the various velocities are easier to read. Thus, in zone Z1 of the image, reference should be made to the shades of grey for the zone Z1 on the corresponding scale. This is the same for the zone Z2.

It will be observed in these FIGS. 8 and 9 that the gas velocities are more homogeneous in the case of the tray in accordance with invention (FIG. 9) than in the case of the tray in accordance with the prior art (FIG. 8).

The proposed invention can also be used to reduce the pressure losses (pressure drops) by 61%.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding French application No. 17/62.231, filed Dec. 15, 2017, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A tray (100) for a column for the exchange of heat and/or matter between a gas and a liquid, comprising:
an upper face and a lower face,
a plurality of chimneys (108) jutting over a portion (101) of the upper face of said tray (100) for the exclusive passage of said gas through said tray (100), said chimneys comprising an opening for the escape of gas at their top, an axis Z passing through them in the direction of their height and being elongated along a longitudinal axis Y orthogonal to the axis Z, and being substantially parallelepipedal and mutually parallel, and
in which at least one of said chimneys (108) is surmounted by a hat (108′) with a streamlined profile in order to prevent the passage of liquid through said chimney (108), said hat (108′) being elevated with respect to the gas escape opening of the chimney (108), said hat (108′) comprising a lower, substantially semi-cylindrical body (180) which is elongated along the longitudinal axis Y and open on the side opposite to the escape opening of the chimney (108), extended laterally by two planar fins (181, 182) inclined towards the axis of revolution (R) of the lower body at an angle θ in the range 0° to 30°with respect to the axis Z, the diameter (D) of the lower body (180) being at least equal to the width (L) of the chimney (108), and the length (1) of the lower body (108) being at least equal to the length (1) of the chimney (108).

2. The tray as claimed in claim 1, in which each chimney (108) is surmounted by a hat (180) with a streamlined profile.

3. The tray as claimed in claim 1, in which the lower body (180) comprises a section in the form of an arc of a circle with a length that is less than or equal to that of a semi-circle and which has an axis of symmetry that coincides with the axis Z, and defines an angle β formed between the centre O of the circle, the axis X and the junction J between a fin and the lower body which is in the range 0° to 30°.

4. The tray as claimed in claim 1, in which the lower body (180) is a half-cylinder.

5. The tray as claimed in claim 1, in which the lower body (180) comprises a section in the form of an arc of a circle with a length that is less than or equal to that of a semi-circle and has an axis of symmetry which coincides with the axis Z, and the length (a) of the fin (181, 182) is in the range 10 mm to a maximum value aₘₐₓ which is equal to aₘₐₓ=(D*cos(β))/(2*sin(θ)), in which β is the angle formed between the centre O of the circle, the axis X and the junction J between the fin (181, 182) and the lower body, θ is the inclination of the fins (181, 182) with respect to the axis Z, and D is the diameter of the lower body (180).

6. The tray as claimed in claim 1, in which said fins (181, 182) are substantially in the shape of a rectangle.

7. The tray as claimed in claim 1, in which said chimneys (108) are substantially in the shape of a parallelepipedal rectangle.

8. The tray as claimed in claim 1, in which at least one of said chimneys (108), and preferably all of said chimneys (108), comprises a dispersive element for gas disposed inside said chimney (108), the dispersive element preferably comprising a perforated plate (103) comprising circular orifices (104) or slots for the passage of gas.

9. The tray as claimed in claim 1, further comprising means for the passage of liquid through the tray and/or a liquid collection zone (109).

10. The tray as claimed in claim 9, for the distribution of gas at the bottom of a column for the exchange of heat and/or matter between a gas and a liquid, in which the collection zone (109) comprises two weirs (109′) which are diametrically opposed and orthogonal to said portion (101) of the upper face of the tray (100) supporting the chimneys (108), said chimneys (108) extending parallel to the weirs (109′).

11. The tray as claimed in claim 9, for the distribution of gas and liquid in a column for the exchange of heat and/or matter between a gas and a liquid, in which the means for the passage of liquid through the tray (100) comprise a plurality of orifices and/or chimneys for the passage of liquid.

12. A column for the exchange of heat and/or matter between a gas and a liquid, comprising at least one gas/liquid contactor (7) bringing the gas (g) and the liquid (1) into contact, and at least one tray (100) as claimed in claim 1 to distribute the gas, and optionally the liquid, over said gas/liquid contactor (7).

13. The column as claimed in claim 12, in which said tray is disposed at the bottom of the column upstream of any gas/liquid contactor (7) in order to distribute the gas at the base of said gas/liquid contactor (7).

14. The column as claimed in claim 12, comprising a plurality of sections, each of said sections comprising a gas/liquid contactor (7), and in which a tray is disposed between an upper section and a lower section, said upper and lower sections being successive in the column, in order to distribute the gas at the base of said gas/liquid contactor (7) of the upper section and to distribute the liquid at the top of the gas/liquid contactor (7) of the lower section.

15. A method which comprises using a column as claimed in claim 12 in a process selected from the group consisting of the treatment of gas, the capture of CO₂, the dehydration of a gas, or distillation.
